(19) United States
(12) Patent Application Publication
(10) Pub. No.: US 2024/0404426 A1
(43) Pub. Date: Dec. 5, 2024

(54) SYSTEM AND METHOD FOR PROVIDING CYBERSECURITY SIMULATION AND TRAINING

(71) Applicant: Beauceron Security Inc., Fredericton (CA)

(72) Inventors: David SHIPLEY, Rusagonis (CA); Sean MCDOUGALL, Beaver Dam (CA)

(21) Appl. No.: 18/326,537

(22) Filed: May 31, 2023

(51) Int. Cl. G09B 19/00

(52) U.S. Cl. CPC G09B 19/0053

(57) ABSTRACT

Computing platforms, systems, methods, and storage media for providing cybersecurity simulation and training are disclosed. Exemplary implementations may: generate a cybersecurity simulation comprising a set of simulation elements selected from a simulation and training database; in response to detection of a cybersecurity simulation completion condition, dynamically generate a cybersecurity training course comprising a set of training elements corresponding to the set of simulation characteristics, the set of training elements selected from the simulation and training database; and in response to identification of a change to the cybersecurity simulation, modify the cybersecurity training course based on the identified change to the cybersecurity simulation.

### FIELD

The present disclosure relates to computing systems, including but not limited to systems, methods, and storage media for providing cybersecurity simulation and training.

### BACKGROUND

Phishing is an approach that is often used to steal or acquire sensitive data, such as login credentials or financial data. Phishing remains the leading cause of cybersecurity incidents and data breaches worldwide.

As a response to phishing, many organizations have implemented computer-based training programs, or phishing simulation training. This is now the industry-standard response. As part of the training program, phishing simulations are sent to users via email or other instant messaging tools. If a user falls for the phishing simulation, for example by clicking on a link or opening an attachment, a landing page pop-up appears on the user's screen to alert them that they have fallen for a phishing scam, and provides access to additional remediation/training.

Improvements in approaches for providing cybersecurity simulation and training are desirable.

### SUMMARY

One aspect of the present disclosure relates to a system configured for providing cybersecurity simulation and training. The system may include one or more hardware processors configured by machine-readable instructions. The processor(s) may be configured to generate a cybersecurity simulation including a set of simulation elements selected from a simulation and training database. The set of simulation elements may be associated with a set of simulation characteristics. The processor(s) may be configured to, in response to detection of a cybersecurity simulation completion condition, dynamically generate a cybersecurity training course including a set of training elements corresponding to the set of simulation characteristics, the set of training elements selected from the simulation and training database. The processor(s) may be configured to, in response to identification of a change to the cybersecurity simulation, modify the cybersecurity training course based on the identified change to the cybersecurity simulation.

Another aspect of the present disclosure relates to a method for providing cybersecurity simulation and training. The method may include generating a cybersecurity simulation including a set of simulation elements selected from a simulation and training database. The set of simulation elements may be associated with a set of simulation characteristics. The method may include, in response to detection of a cybersecurity simulation completion condition, dynamically generating a cybersecurity training course including a set of training elements corresponding to the set of simulation characteristics, the set of training elements selected from the simulation and training database. The method may include, in response to identification of a change to the cybersecurity simulation, modifying the cybersecurity training course based on the identified change to the cybersecurity simulation.

Yet another aspect of the present disclosure relates to a non-transient computer-readable storage medium having instructions embodied thereon, the instructions being executable by one or more processors to perform a method for providing cybersecurity simulation and training. The method may include generating a cybersecurity simulation including a set of simulation elements selected from a simulation and training database. The set of simulation elements may be associated with a set of simulation characteristics. The method may include, in response to detection of a cybersecurity simulation completion condition, dynamically generating a cybersecurity training course including a set of training elements corresponding to the set of simulation characteristics, the set of training elements selected from the simulation and training database. The method may include, in response to identification of a change to the cybersecurity simulation, modifying the cybersecurity training course based on the identified change to the cybersecurity simulation.

### BRIEF DESCRIPTION OF THE DRAWINGS

Embodiments of the present disclosure will now be described, by way of example only, with reference to the attached Figures.

FIG. 1 illustrates a system configured for providing cybersecurity simulation and training, in accordance with one or more implementations.

FIG. 2 illustrates a system configured for providing cybersecurity simulation and training, in accordance with one or more implementations.

FIG. 3 illustrates a method for providing cybersecurity simulation and training, in accordance with one or more implementations.

FIG. 4 illustrates an example screenshot of a cybersecurity simulation editor user interface according to one or more embodiments.

FIG. 5. Illustrates an example screenshot of a cybersecurity simulation according to one or more embodiments.

FIG. 6 illustrates a first example screenshot of a portion of a cybersecurity training course according to one or more embodiments.

FIG. 7 illustrates a second example screenshot of a portion of a cybersecurity training course according to one or more embodiments.

### DETAILED DESCRIPTION

Computing platforms, systems, methods, and storage media for providing cybersecurity simulation and training are disclosed. Exemplary implementations may: generate a cybersecurity simulation comprising a set of simulation elements selected from a simulation and training database; in response to detection of a cybersecurity simulation completion condition, dynamically generate a cybersecurity training course comprising a set of training elements corresponding to the set of simulation characteristics, the set of training elements selected from the simulation and training database; and in response to identification of a change to the cybersecurity simulation, modify the cybersecurity training course based on the identified change to the cybersecurity simulation.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

According to known approaches, if a user falls for a phishing simulation, for example by clicking on a link or opening an attachment, a landing page pop-up may be generated and displayed on the user's screen to alert them that they have fallen for a phishing scam, and provides access to additional remediation/training. However, less than 10% of users that fall victim to a simulated phishing scam stop to read the information on the landing page. The immediate response of 90% of users is to quickly close the pop-up, out of fear and panic. Because the users typically panic at the moment of the incident, they are less likely to learn anything from the training or details provided via the pop-up landing page. The current industry standard is also to provide generic phishing related training courses, which are not specific to the actual experience of users that fell victim to a phish.

An additional problem is that phish awareness often includes teaching users to spot spelling errors, and identify links that seem questionable. However, advances in technology and AI have resulted in a phish being created with little to no spelling errors. Furthermore, additional security measures may modify URLs so that it is nearly impossible to identify, based on appearance of a URL, whether the URL is legitimate or not.

Users need customized training, which is not currently being offered because of the resources and computing power needed to create custom training modules for each user.

A technical problem is that current approaches require significant computing resources, such as processor resources and/or memory resources, to generate cybersecurity training simulations. It is unreasonable using current approaches to generate customized cybersecurity training simulations, based on the computing resource requirements.

Another technical problem is the technical disconnect between generation of cybersecurity simulations, and generation of cybersecurity training courses. Cybersecurity simulations are typically generated using a first system having first system resources. Cybersecurity training courses are typically generated using a second system having second system resources. According to known approaches, in addition to using a large number of resources in two different systems in order to generate cybersecurity simulations and related training courses, there is often no straightforward way to compare or associate the technical content of a cybersecurity simulation with the technical training content of a cybersecurity training course.

Accordingly, advances in cybersecurity and specifically phish awareness training are needed, and are provided by embodiments of the present disclosure. According to one or more embodiments of the present disclosure, a system is configured to generate a cybersecurity simulation having a set of simulation characteristics, and to dynamically generate a cybersecurity training course comprising a set of training elements corresponding to the set of simulation characteristics from the cybersecurity simulation. According to one or more embodiments, the system may generate the cybersecurity simulation using a set of simulation elements selected from a simulation and training database. The system may also generate the cybersecurity training course using a set of training elements corresponding to the set of simulation characteristics, and using the same simulation and training database.

According to one or more embodiments, the present disclosure provides a dynamically generated phishing/cybersecurity awareness training and education platform. This training platform addresses a gap in education related to a specific phish experienced by a user when they panic and may close a landing page pop-up.

According to one or more embodiments, a simulated phish is provided to a user. Based on a user's interaction with the phish, the system may dynamically create a training course, or learning module, specific to that user's experience. A short time, such as few minutes, after the experience, the system may prompt the user to complete the learning module. The simulated phish may be tailored based on emotional intent and other criteria and may be customized by each organization. According to one or more embodiments, a delayed response is sent via email (or instant message or otherwise), for example a few minutes after the user clicks on the phish. The delayed response may prompt the user to complete a training program on the cybersecurity awareness platform that is dynamically generated based on the user's experience, i.e. the specific phish they fell for. Because the assigned training course is specific to the phish the user fell for, it includes details on how the user could recognize such a phish in future and why they may have fallen victim to the phish in the first place.

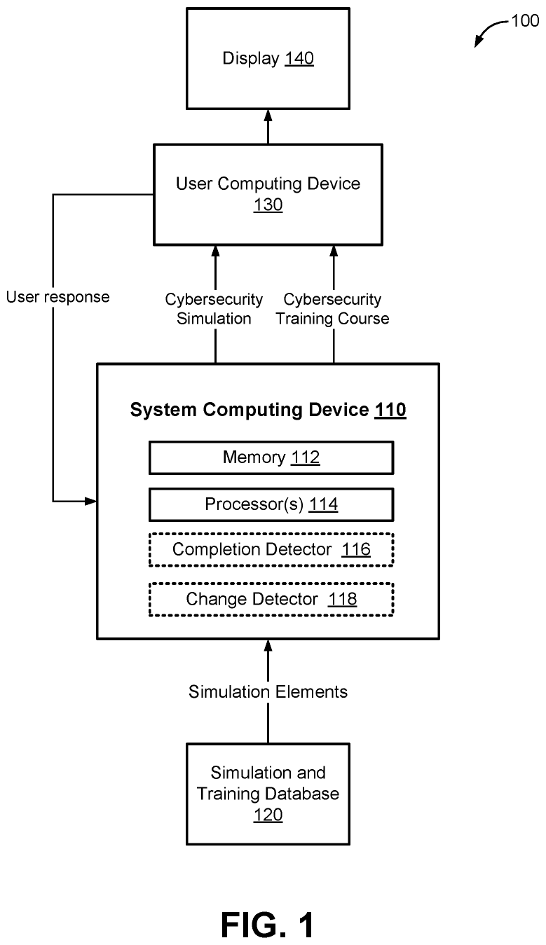

FIG. 1 illustrates a system 100 configured for providing cybersecurity simulation and training, in accordance with one or more implementations. The system 100 comprises a system computing device 110, which is in communication with a simulation and training database 120 and with a user computing device 130. The system computing device 110 may include a non-transitory machine-readable memory 112 and one or more hardware processors 114 configured by machine-readable instructions stored in the non-transitory machine-readable memory 112.

The processor(s) 114 may be configured to generate a cybersecurity simulation including a set of simulation elements selected from the simulation and training database 120. The set of simulation elements may be associated with a set of simulation characteristics. The cybersecurity simulation may be provided to the user computing device via a display 140 associated with, or in communication with, the user computing device 130. The processor(s) 114 may be configured to, in response to detection of a cybersecurity simulation completion condition, dynamically generate a cybersecurity training course. The cybersecurity training course may be provided to the user computing device via a display 140 associated with, or in communication with, the user computing device 130.

A completion detector 116 may be configured to detect the cybersecurity simulation completion condition. In an example embodiment, detecting the cybersecurity simulation completion condition comprises detecting a user response to the cybersecurity simulation. In an example embodiment, detecting the cybersecurity simulation completion condition comprises detection of completion of the cybersecurity simulation, or expiry of the cybersecurity simulation.

The cybersecurity training course dynamically generated by the system computing device 110 may include a set of training elements corresponding to the set of simulation characteristics from the cybersecurity simulation. The set of training elements in the cybersecurity training course may be selected from the simulation and training database 120. The set of simulation elements from the cybersecurity simulation may be selected from the simulation and training database 120.

In this way, the system computing device 110 may advantageously dynamically generate the cybersecurity training course based on similar elements or building blocks as were used to generate the cybersecurity simulation. This may address the technical problem of a disconnect between a cybersecurity simulation and a cybersecurity training course, since a common set of building blocks may be used to generate both the simulation and the training course, in accordance with one or more embodiments. This eliminates the need to determine a correspondence or translation between aspects of the simulation and aspects of the training course.

The system computing device 110 may comprise a change detector 118. The processor(s) 114 may be configured to, in response to identification of a change to the cybersecurity simulation, for example by the change detector 118, modify the cybersecurity training course based on the identified change to the cybersecurity simulation. In an example embodiment, the identification of the change to the cybersecurity simulation comprises an automatic identification of the change.

This aspect addresses a first technical problem of having out-of-date training courses that do not reflect changes in a related cybersecurity simulation. Without a technical solution for identifying or detecting a change in a cybersecurity simulation, a system cannot be configured to automatically modify a related cybersecurity training course. In an example embodiment, automatic identification of a change in the cybersecurity simulation, and automatic modification of the cybersecurity training course, enable the system to scale and to address a high volume of change identifications and modifications, without having to involve a user or technical person.

This aspect also addresses a second technical problem of having to manually create or re-generate a customized training course. This is typically done manually according to known approaches, and is often not even done at all due to the difficulty of identifying changes and of modifying a training course based on the change. In an example embodiment, the change detector 118 is configured to detect the change, and the system computing device 110 is configured to modify the cybersecurity training course based on the identified change in the cybersecurity simulation. In an example embodiment, because elements of the cybersecurity simulation and elements of the cybersecurity training course may be selected from the same simulation and training database 120, this enables the system computing device 110 to modify the training course based on the identified change in the simulation.

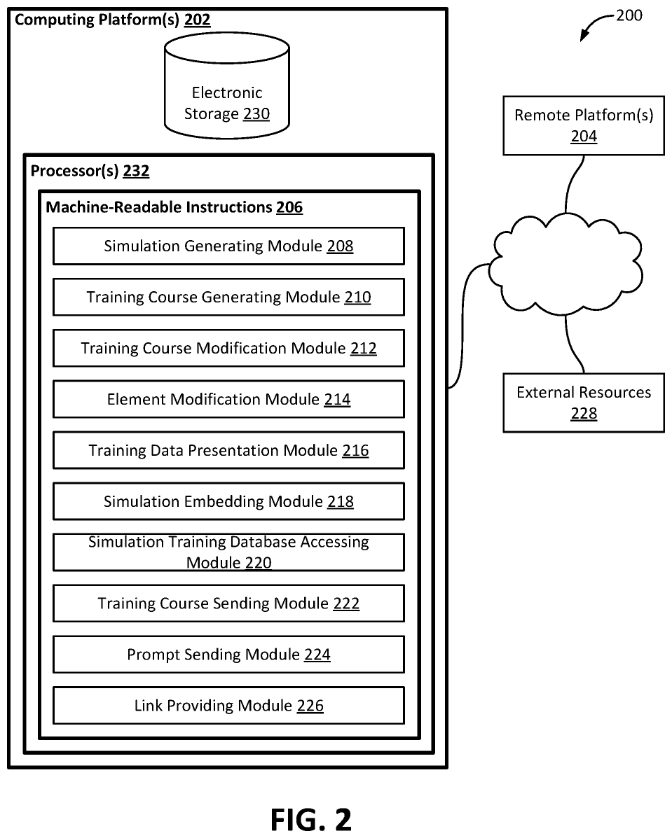

FIG. 2 illustrates a system 200 configured for providing cybersecurity simulation and training, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of simulation generating module 208, training course generating module 210, training course modification module 212, element modification module 214, training data presentation module 216, simulation embedding module 218, simulation training database accessing module 220, training course sending module 222, prompt sending module 224, link providing module 226, and/or other instruction modules.

Simulation generating module 208 may be configured to generate a cybersecurity simulation including a set of simulation elements selected from a simulation and training database. The cybersecurity simulation may include a simulation identifier. The set of simulation elements may be associated with a set of simulation characteristics.

Training course generating module 210 may be configured to, in response to detection of a cybersecurity simulation completion condition, dynamically generate a cybersecurity training course including a set of training elements corresponding to the set of simulation characteristics. The set of training elements may be selected from the simulation and training database. The cybersecurity simulation completion condition may comprise a user response to the cybersecurity simulation or expiry of the cybersecurity simulation. The cybersecurity training course may comprise training data delivered using a presentation format.

A presentation format may be any one or more of a display format on a user device, a graphical user interface or any other visual interface for presenting the cybersecurity training course. The presentation format may be provided on any suitable display screen or other display device configured to convey the training data delivered using the presentation format. The presentation format may comprise a set of display elements or presentation elements, and may comprise a specific arrangement or selection of display elements or presentation elements.

By way of non-limiting example, sending the prompt to the user may include generating and sending an email, text, or instant message prompt with a link to the cybersecurity training course. Sending the cybersecurity training course to the user may include sending the user a link to the cybersecurity training course hosted on an external platform. The cybersecurity simulation may be sent to the user at a time t1 and the cybersecurity training course may be sent to the user at a time t2, wherein the time t2 is after the detection of the cybersecurity simulation completion condition. The time t2 may be a few minutes after t1, or may be at least 5 seconds after the detection of the cybersecurity simulation completion condition. The timing of the delay between t1 and t2 may be selected or modified based on one or more factors including technical constraints, network parameters, type of simulation, difficulty of simulation, among other factors.

Training course generating module 210 may be configured to dynamically generate training data for the cybersecurity training course based on the simulation identifier.

Training course modification module 212 may be configured to, in response to identification of a change to the cybersecurity simulation, modify the cybersecurity training course based on the identified change to the cybersecurity simulation.

Element modification module 214 may be configured to, in response to identification of a change to the set of simulation elements, modify the set of training elements based on the identified change to the set of simulation elements.

Element modification module 214 may be configured to, in response to identification of a change to the set of simulation characteristics, modify the set of training elements based on the identified change to the set of simulation characteristics.

Training data presentation module 216 may be configured to dynamically present the training data using a presentation format based on a user identifier. For example, the training data presentation module 216 may be configured to present training data to a first user using a first presentation format based on a first user identifier. The training data presentation module 216 may be configured to present the same training data to a second user using a second presentation format based on a second user identifier. The second presentation format may have characteristics similar to the presentation format as described earlier.

Simulation embedding module 218 may be configured to embed at least a portion of the cybersecurity simulation in the cybersecurity training course. For example, to assist with education, the training course may include a screenshot or some other representation or portion of the simulation in the training course. Including a portion of the actual simulation may result in a more relevant training course, increasing the likelihood of success in the training.

Simulation training database accessing module 220 may be configured to access the simulation and training database to select the set of simulation elements. By way of non-limiting example, the set of simulation elements may include one or more of emotional intent criteria adjusters, cues for identifying a phish or other cybersecurity scam, difficulty level of the cybersecurity simulation based on context and relevancy to the organization or the end user, explanations and/or advice for identifying future cybersecurity scams, and user personality adjusters.

Training course sending module 222 may be configured to send the cybersecurity training course to the user via email, text, or instant message.

Prompt sending module 224 may be configured to send a prompt to the user at the time t2 to complete the cybersecurity training course.

Link providing module 226 may be configured to provide the user with a link to an external platform with an option to access the cybersecurity training course.

In some embodiments, computing platform(s) 202, remote platform(s) 204, and/or external resources 228 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 228 may be operatively linked via some other communication media.

A given remote platform 204 may include one or more processors configured to execute computer program modules. The computer program modules may be configured to enable an expert or user associated with the given remote platform 204 to interface with system 200 and/or external resources 228, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 228 may include sources of information outside of system 200, external entities participating with system 200, and/or other resources. In some embodiments, some or all of the functionality attributed herein to external resources 228 may be provided by resources included in system 200.

Computing platform(s) 202 may include electronic storage 230, one or more processors 232, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 230 may comprise non-transitory storage media that electronically stores information. The electronic storage media of electronic storage 230 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 230 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 230 may include one or more virtual storage resources (e.g., cloud storage, a virtual private network, and/or other virtual storage resources). Electronic storage 230 may store software algorithms, information determined by processor(s) 232, information received from computing platform(s) 202, information received from remote platform(s) 204, and/or other information that enables computing platform(s) 202 to function as described herein.

Processor(s) 232 may be configured to provide information processing capabilities in computing platform(s) 202. As such, processor(s) 232 may include one or more of a digital processor, an analog processor, a digital circuit designed to process information, an analog circuit designed to process information, a state machine, and/or other mechanisms for electronically processing information. Although processor(s) 232 is shown in FIG. 2 as a single entity, this is for illustrative purposes only. In some embodiments, processor(s) 232 may include a plurality of processing units. These processing units may be physically located within the same device, or processor(s) 232 may represent processing functionality of a plurality of devices operating in coordination. Processor(s) 232 may be configured to execute modules 208, 210, 212, 214, 216, 218, 220, 222, 224, and/or 226, and/or other modules. Processor(s) 232 may be configured to execute modules 208, 210, 212, 214, 216, 218, 220, 222, 224, and/or 226, and/or other modules by software; hardware; firmware; some combination of software, hardware, and/or firmware; and/or other mechanisms for configuring processing capabilities on processor(s) 232. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, 222, 224, and/or 226 are illustrated in FIG. 2 as being implemented within a single processing unit, in embodiments in which processor(s) 232 includes multiple processing units, one or more of modules 208, 210, 212, 214, 216, 218, 220, 222, 224, and/or 226 may be implemented remotely from the other modules. The description of the functionality provided by the different modules 208, 210, 212, 214, 216, 218, 220, 222, 224, and/or 226 described herein is for illustrative purposes, and is not intended to be limiting, as any of modules 208, 210, 212, 214, 216, 218, 220, 222, 224, and/or 226 may provide more or less functionality than is described. For example, one or more of modules 208, 210, 212, 214, 216, 218, 220, 222, 224, and/or 226 may be eliminated, and some or all of its functionality may be provided by other ones of modules 208, 210, 212, 214, 216, 218, 220, 222, 224, and/or 226. As another example, processor(s) 232 may be configured to execute one or more additional modules that may perform some or all of the functionality attributed below to one of modules 208, 210, 212, 214, 216, 218, 220, 222, 224, and/or 226.

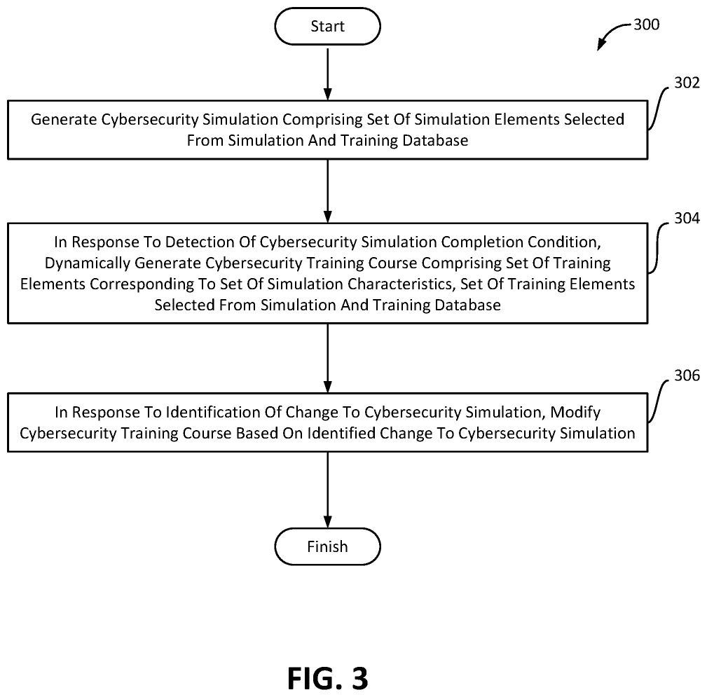

FIG. 3 illustrates a method 300 for providing cybersecurity simulation and training, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include generating a cybersecurity simulation including a set of simulation elements selected from a simulation and training database. The set of simulation elements may be associated with a set of simulation characteristics. Operation 302 may be performed by one or more hardware processors configured by machine-readable instructions including a module that is the same as or similar to simulation generating module 208, in accordance with one or more embodiments.

An operation 304 may include in response to detection of a cybersecurity simulation completion condition, dynamically generating a cybersecurity training course including a set of training elements corresponding to the set of simulation characteristics, the set of training elements selected from the simulation and training database. Operation 304 may be performed by one or more hardware processors configured by machine-readable instructions including a module that is the same as or similar to training course generating module 210, in accordance with one or more embodiments.

An operation 306 may include in response to identification of a change to the cybersecurity simulation, modifying the cybersecurity training course based on the identified change to the cybersecurity simulation. Operation 306 may be performed by one or more hardware processors configured by machine-readable instructions including a module that is the same as or similar to training course modification module 212, in accordance with one or more embodiments.

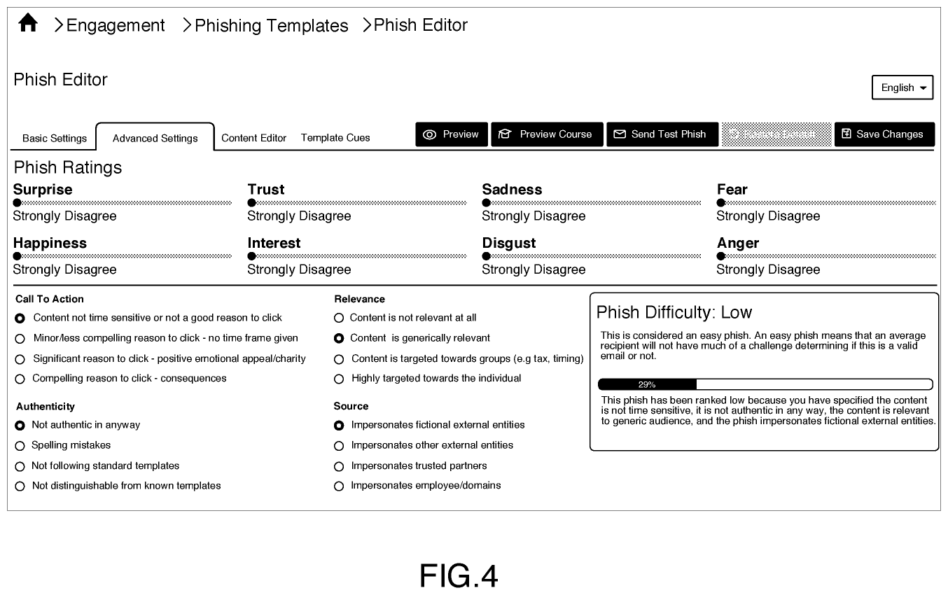

FIG. 4 illustrates an example screenshot 400 of a cybersecurity simulation editor user interface according to one or more embodiments. In an example embodiment, the cybersecurity simulation editor user interface may be used for setting up a phish that can be sent to users. As seen in FIG. 4, the phish may be tailored based on emotional intent. The phish may also be scored on a difficulty rating based on the emotional intent as well as other categories such as: call to action, relevance, authenticity, and source. In an example embodiment, the NIST (national institute of standards and technology) phish scale may be used to scale the phish.

The difficulty of the phish that was experienced by the user may be displayed to the user in the training course so that the user may be informed as to whether it was a difficult phish to spot or not and why it was difficult. For example, the phish may have targeted specific emotions and hard to identify phish cues. The dynamically generated training course may further provide an explanation to give users advice on how to avoid falling victim to a phish that targets similar emotions or includes similar cues.

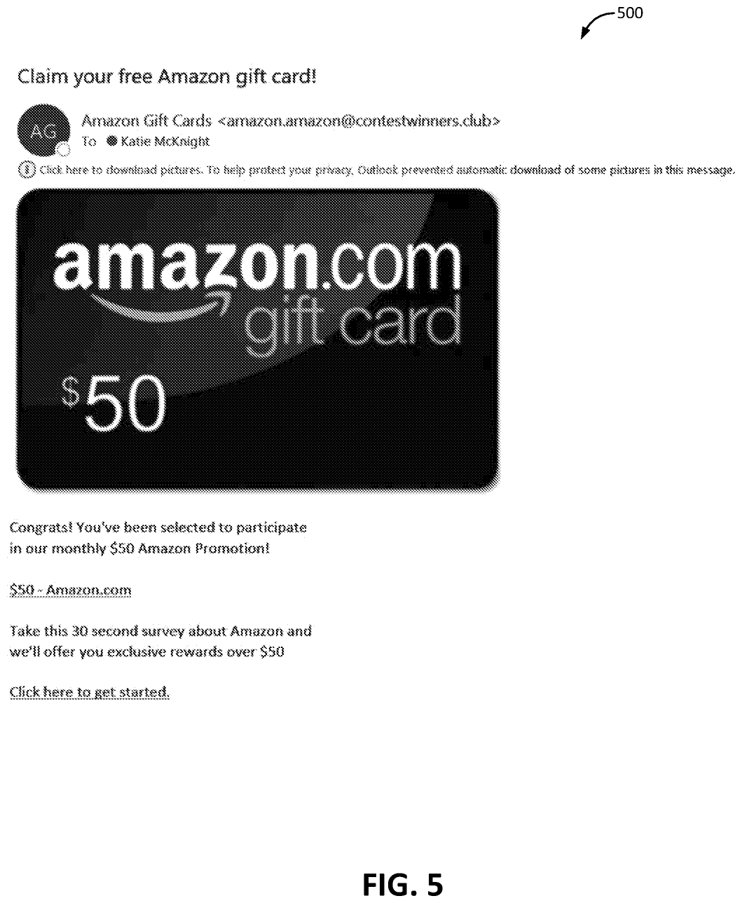

FIG. 5. Illustrates an example screenshot 500 of a cybersecurity simulation according to one or more embodiments. The example shown in FIG. 5 illustrates an example cybersecurity simulation comprising a phish that may be sent and displayed to a user. The phish may comprise, for example, suspicious links and promotions encouraging a user to click the links. The phish or other cybersecurity simulation may be tailored using the cybersecurity editor, for example as shown in FIG. 4.

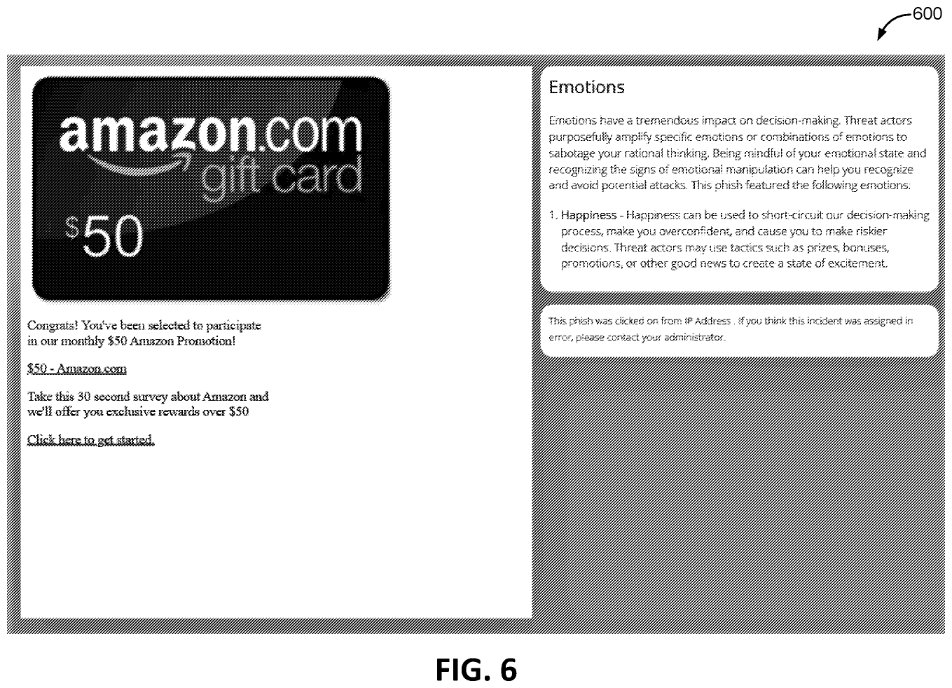

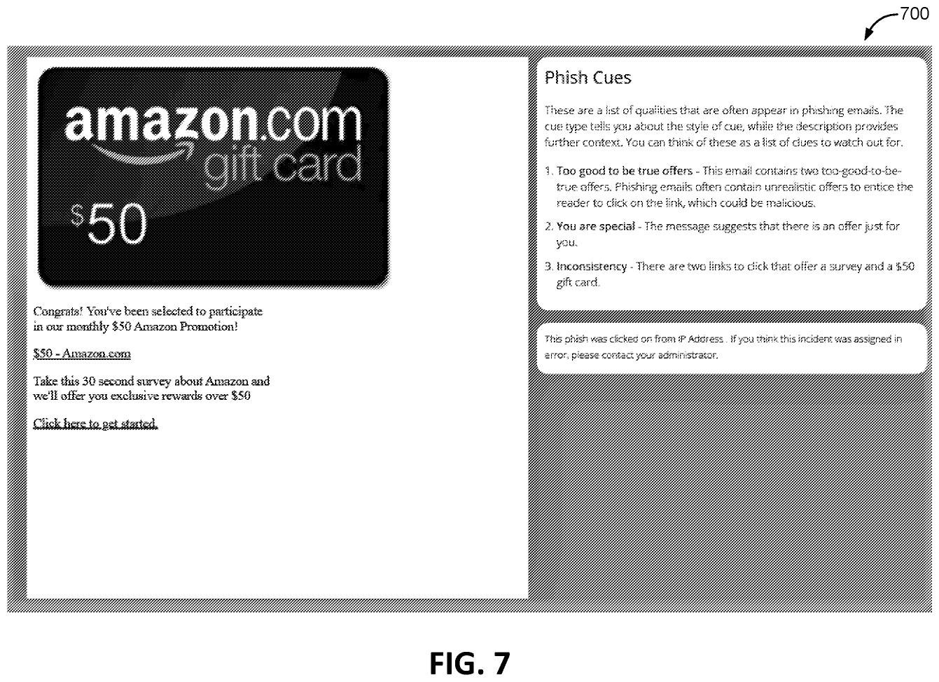

FIG. 6 and FIG. 7 illustrate first and second example screenshots 600 and 700, respectively, of a portion of a cybersecurity training course according to one or more embodiments. For example, FIG. 6 and FIG. 7 illustrate examples of screens that may appear in a portion of the dynamically generated cybersecurity training course related to the cybersecurity simulation shown in FIG. 5. The cybersecurity training course may be dynamically generated in response to a cybersecurity simulation completion condition, for example, a user response to the cybersecurity simulation by clicking or interacting with one or more links or features of the simulation, or the expiry of the simulation, which may be for example after a prescribed amount of time after the email has been “read” or if the email is discarded.

As illustrated in FIG. 6 and FIG. 7, the cybersecurity training course may be directly related to the cybersecurity simulation sent to the user, for example, by showing a copy of the simulation that triggered the course generation. The training course may for example provide details as shown at 600 on the emotional intent behind the cybersecurity simulation as shown in FIG. 6, and how a user can identify that a cybersecurity threat is trying to influence decision making by using emotions. As illustrated in FIG. 7, the cybersecurity training course may also provide details as shown at 700 including a list of cues that a user can look for to identify the specific cybersecurity simulation and other similar cybersecurity threats in future. The cybersecurity training course may include more or less than the details or screens provided in FIG. 6 and FIG. 7 and may be tailored for specific users or companies.

In some embodiments, the cybersecurity simulation comprises a phish. In other embodiments, the cybersecurity simulation may comprise or look like a phish, spam, or a real email. The end user may report an email as any one of these three categories. For example, if a system administrator wanted to see how well their users detect spam, the administrator could configure the system to send an email that looks like spam, and if a user clicks on the email, provide the same dynamic content but the details would be relating to this spam email, not a phish.

In another aspect, the present disclosure provides a system and method configured to provide customized training based on a cybersecurity action, where the cybersecurity action may comprise a real phish or a simulated phish.

In an embodiment, the present disclosure provides a method of providing cybersecurity training, comprising: detecting a user response to a cybersecurity action, the cybersecurity action being associated with a set of cybersecurity characteristics, the user response comprising a user identifier; dynamically generating training data for a cybersecurity training course based on the detected user response, the training data being dynamically generated based on the set of cybersecurity characteristics; and dynamically presenting the training data to a user using a presentation format, the presentation format based on the user identifier. Dynamically presenting the training data may comprise, for example, presenting the training data on a display or other graphical user interface.

In an example implementation, the cybersecurity action comprises a real cybersecurity threat or a cybersecurity simulation. In an example implementation, the cybersecurity action comprises a phish.

In an example implementation, the set of cybersecurity characteristics comprises any one or more of, emotional intent criteria, a cybersecurity type, and a difficulty level associated with the cybersecurity action.

In an example implementation, the dynamically generated training data comprises explanations and/or advice for identifying future cybersecurity actions similar the cybersecurity action.

In an example implementation, the user identifier identifies one or more of: the user's age, social class, position in a company, seniority, background, and personality.

In an example implementation, presenting the training data includes presenting at least a portion of the cybersecurity action back to the user with advice.

In another aspect, the present disclosure provides a method and system configured to provide cybersecurity simulation and training. In an embodiment, the present disclosure provides a method of providing cybersecurity simulation and training, comprising: generating a cybersecurity simulation comprising a set of simulation elements associated with a set of simulation characteristics; in response to detection of a user response to the cybersecurity simulation, dynamically generating a cybersecurity training course comprising a set of training elements corresponding to the set of simulation characteristics; in response to identification of a change to the cybersecurity simulation, modifying the cybersecurity training course based on the identified change to the cybersecurity simulation.

In an example embodiment, the set of simulation elements is selected from a simulation and training database, and the set of training elements is selected from the simulation and training database.

Embodiments of the disclosure can also be described with reference to the following clauses.

One aspect of the present disclosure relates to a system configured for providing cybersecurity simulation and training. The system may include one or more hardware processors configured by machine-readable instructions. The processor(s) may be configured to generate a cybersecurity simulation including a set of simulation elements selected from a simulation and training database. The set of simulation elements may be associated with a set of simulation characteristics. The processor(s) may be configured to, in response to detection of a cybersecurity simulation completion condition, dynamically generate a cybersecurity training course including a set of training elements corresponding to the set of simulation characteristics, the set of training elements selected from the simulation and training database. The processor(s) may be configured to, in response to identification of a change to the cybersecurity simulation, modify the cybersecurity training course based on the identified change to the cybersecurity simulation.

In some implementations of the system, the cybersecurity simulation completion condition may include a user response to the cybersecurity simulation or expiry of the cybersecurity simulation.

In some implementations of the system, the processor(s) may be configured to, in response to identification of a change to the set of simulation elements, modify the set of training elements based on the identified change to the set of simulation elements.

In some implementations of the system, the processor(s) may be configured to, in response to identification of a change to the set of simulation characteristics, modify the set of training elements based on the identified change to the set of simulation characteristics.

In some implementations of the system, the cybersecurity simulation may include a simulation identifier. In some implementations of the system, the processor(s) may be configured to dynamically generate training data for the cybersecurity training course based on the simulation identifier.

In some implementations of the system, the cybersecurity training course includes training data and may be delivered using a presentation format. In some implementations of the system, the processor(s) may be configured to dynamically generate training data for the cybersecurity training course based on the simulation identifier. In some implementations of the system, the processor(s) may be configured to dynamically present the training data using a presentation format based on a user identifier.

In some implementations of the system, the processor(s) may be configured to embed at least a portion of the cybersecurity simulation in the cybersecurity training course.

In some implementations of the system, the processor(s) may be configured to access the simulation and training database to select the set of simulation elements. In some implementations of the system, the set of simulation elements may include one or more of emotional intent criteria adjusters, cues for identifying a phish or other cybersecurity scam, difficulty level of the cybersecurity simulation based on context and relevancy to the organization or the end user, explanations and/or advice for identifying future cybersecurity scams, and user personality adjusters.

In some implementations of the system, the processor(s) may be configured to send the cybersecurity training course to the user via email, text, or instant message.

In some implementations of the system, sending the cybersecurity training course to the user may include sending the user a link to the cybersecurity training course hosted on an external platform.

In some implementations of the system, the cybersecurity simulation may be sent to the user at a time t1 and the cybersecurity training course is sent to the user at a time t2 wherein the time t2 is after the detection of the cybersecurity simulation completion condition.

In some implementations of the system, the time t2 may be at least 5 seconds after the detection of the cybersecurity simulation completion condition.

In some implementations of the system, the processor(s) may be configured to send a prompt to the user at the time t2 to complete the cybersecurity training course.

In some implementations of the system, sending the prompt to the user may include generating and sending an email, text, or instant message prompt with a link to the cybersecurity training course.

In some implementations of the system, the cybersecurity simulation completion condition may include the expiry of the cybersecurity simulation. In some implementations of the system, the processor(s) may be configured to provide the user with a link to an external platform with an option to access the cybersecurity training course.

Another aspect of the present disclosure relates to a method for providing cybersecurity simulation and training. The method may include generating a cybersecurity simulation including a set of simulation elements selected from a simulation and training database. The set of simulation elements may be associated with a set of simulation characteristics. The method may include, in response to detection of a cybersecurity simulation completion condition, dynamically generating a cybersecurity training course including a set of training elements corresponding to the set of simulation characteristics, the set of training elements selected from the simulation and training database. The method may include, in response to identification of a change to the cybersecurity simulation, modifying the cybersecurity training course based on the identified change to the cybersecurity simulation.

In some implementations of the method, the cybersecurity simulation completion condition may include a user response to the cybersecurity simulation or expiry of the cybersecurity simulation.

In some implementations of the method, the method may include, in response to identification of a change to the set of simulation elements, modifying the set of training elements based on the identified change to the set of simulation elements.

In some implementations of the method, the method may include, in response to identification of a change to the set of simulation characteristics, modifying the set of training elements based on the identified change to the set of simulation characteristics.

In some implementations of the method, the cybersecurity simulation may include a simulation identifier. In some implementations of the method, the method may include dynamically generating training data for the cybersecurity training course based on the simulation identifier.

In some implementations of the method, the cybersecurity simulation may include a simulation identifier. In some implementations of the method, the cybersecurity training course may include training data delivered in a presentation format. In some implementations of the method, the method may include dynamically generating training data for the cybersecurity training course based on the simulation identifier. In some implementations of the method, the method may include dynamically presenting the training data using a presentation format based on a user identifier.

In some implementations of the method, the method may further include embedding at least a portion of the cybersecurity simulation in the cybersecurity training course.

In some implementations of the method, the method may further include accessing the simulation and training database to select the set of simulation elements. In some implementations of the method, the set of simulation elements may include one or more of emotional intent criteria adjusters, cues for identifying a phish or other cybersecurity scam, difficulty level of the cybersecurity simulation based on context and relevancy to the organization or the end user, explanations and/or advice for identifying future cybersecurity scams, and user personality adjusters.

In some implementations of the method, the method may further include sending the cybersecurity training course to the user via email, text, or instant message.

In some implementations of the method, sending the cybersecurity training course to the user may include sending the user a link to the cybersecurity training course hosted on an external platform.

In some implementations of the method, the cybersecurity simulation may be sent to the user at a time t1 and the cybersecurity training course is sent to the user at a time t2 wherein the time t2 is after the detection of the cybersecurity simulation completion condition.

In some implementations of the method, the time t2 may be at least 5 seconds after the detection of the cybersecurity simulation completion condition.

In some implementations of the method, the method may further include sending a prompt to the user at the time t2 to complete the cybersecurity training course.

In some implementations of the method, sending the prompt to the user may include generating and sending an email, text, or instant message prompt with a link to the cybersecurity training course.

In some implementations of the method, the cybersecurity simulation completion condition may include the expiry of the cybersecurity simulation. In some implementations of the method, the method may include providing the user with a link to an external platform with an option to access the cybersecurity training course.

Yet another aspect of the present disclosure relates to a non-transient computer-readable storage medium having instructions embodied thereon, the instructions being executable by one or more processors to perform a method for providing cybersecurity simulation and training. The method may include generating a cybersecurity simulation including a set of simulation elements selected from a simulation and training database. The set of simulation elements may be associated with a set of simulation characteristics. The method may include, in response to detection of a cybersecurity simulation completion condition, dynamically generating a cybersecurity training course including a set of training elements corresponding to the set of simulation characteristics, the set of training elements selected from the simulation and training database. The method may include, in response to identification of a change to the cybersecurity simulation, modifying the cybersecurity training course based on the identified change to the cybersecurity simulation.

In some implementations of the computer-readable storage medium, the cybersecurity simulation completion condition may include a user response to the cybersecurity simulation or expiry of the cybersecurity simulation.

In some implementations of the computer-readable storage medium, the method may include, in response to identification of a change to the set of simulation elements, modifying the set of training elements based on the identified change to the set of simulation elements.

In some implementations of the computer-readable storage medium, the method may include, in response to identification of a change to the set of simulation characteristics, modifying the set of training elements based on the identified change to the set of simulation characteristics.

In some implementations of the computer-readable storage medium, the cybersecurity simulation may include a simulation identifier. In some implementations of the computer-readable storage medium, the method may include dynamically generating training data for the cybersecurity training course based on the simulation identifier.

In some implementations of the computer-readable storage medium, the cybersecurity simulation may include a simulation identifier. In some implementations of the computer-readable storage medium, the cybersecurity training course may include training data delivered in a presentation format. In some implementations of the computer-readable storage medium, the method may include dynamically generating training data for the cybersecurity training course based on the simulation identifier. In some implementations of the computer-readable storage medium, the method may include dynamically presenting the training data using a presentation format based on a user identifier.

In some implementations of the computer-readable storage medium, the method may further include embedding at least a portion of the cybersecurity simulation in the cybersecurity training course.

In some implementations of the computer-readable storage medium, the method may further include accessing the simulation and training database to select the set of simulation elements. In some implementations of the computer-readable storage medium, the set of simulation elements may include one or more of emotional intent criteria adjusters, cues for identifying a phish or other cybersecurity scam, difficulty level of the cybersecurity simulation based on context and relevancy to the organization or the end user, explanations and/or advice for identifying future cybersecurity scams, and user personality adjusters.

In some implementations of the computer-readable storage medium, the method may include further including sending the cybersecurity training course to the user via email, text, or instant message.

In some implementations of the computer-readable storage medium, sending the cybersecurity training course to the user may include sending the user a link to the cybersecurity training course hosted on an external platform.

In some implementations of the computer-readable storage medium, the cybersecurity simulation may be sent to the user at a time t1 and the cybersecurity training course is sent to the user at a time t2 wherein the time t2 is after the detection of the cybersecurity simulation completion condition.

In some implementations of the computer-readable storage medium, the time t2 may be at least 5 seconds after the detection of the cybersecurity simulation completion condition.

In some implementations of the computer-readable storage medium, the method may further include sending a prompt to the user at the time t2 to complete the cybersecurity training course.

In some implementations of the computer-readable storage medium, sending the prompt to the user may include generating and sending an email, text, or instant message prompt with a link to the cybersecurity training course.

In some implementations of the computer-readable storage medium, the cybersecurity simulation completion condition may include the expiry of the cybersecurity simulation. In some implementations of the computer-readable storage medium, the method may include providing the user with a link to an external platform with an option to access the cybersecurity training course.

Still another aspect of the present disclosure relates to a system configured for providing cybersecurity simulation and training. The system may include means for generating a cybersecurity simulation including a set of simulation elements selected from a simulation and training database. The set of simulation elements may be associated with a set of simulation characteristics. The system may include means for, in response to detection of a cybersecurity simulation completion condition, dynamically generating a cybersecurity training course including a set of training elements corresponding to the set of simulation characteristics, the set of training elements selected from the simulation and training database. The system may include means for, in response to identification of a change to the cybersecurity simulation, modifying the cybersecurity training course based on the identified change to the cybersecurity simulation.

In some implementations of the system, the cybersecurity simulation completion condition may include a user response to the cybersecurity simulation or expiry of the cybersecurity simulation.

In some implementations of the system, the system may include means for, in response to identification of a change to the set of simulation elements, modifying the set of training elements based on the identified change to the set of simulation elements.

In some implementations of the system, the system may include means for, in response to identification of a change to the set of simulation characteristics, modifying the set of training elements based on the identified change to the set of simulation characteristics.

In some implementations of the system, the cybersecurity simulation may include a simulation identifier. In some implementations of the system, the system may include means for dynamically generating training data for the cybersecurity training course based on the simulation identifier.

In some implementations of the system, the cybersecurity simulation may include a simulation identifier. In some implementations of the system, the cybersecurity training course may include training data delivered in a presentation format. In some implementations of the system, the system may include means for dynamically generating training data for the cybersecurity training course based on the simulation identifier. In some implementations of the system, the system may include means for dynamically presenting the training data using a presentation format based on a user identifier.

In some implementations of the system, the system may further include means for embedding at least a portion of the cybersecurity simulation in the cybersecurity training course.

In some implementations of the system, the system may further include means for accessing the simulation and training database to select the set of simulation elements. In some implementations of the system, the set of simulation elements may include one or more of emotional intent criteria adjusters, cues for identifying a phish or other cybersecurity scam, difficulty level of the cybersecurity simulation based on context and relevancy to the organization or the end user, explanations and/or advice for identifying future cybersecurity scams, and user personality adjusters.

In some implementations of the system, the system may include means for further including sending the cybersecurity training course to the user via email, text, or instant message.

In some implementations of the system, sending the cybersecurity training course to the user may include sending the user a link to the cybersecurity training course hosted on an external platform.

In some implementations of the system, the cybersecurity simulation may be sent to the user at a time t1 and the cybersecurity training course is sent to the user at a time t2 wherein the time t2 is after the detection of the cybersecurity simulation completion condition.

In some implementations of the system, the time t2 may be at least 5 seconds after the detection of the cybersecurity simulation completion condition.

In some implementations of the system, the system may include means for further including sending a prompt to the user at the time t2 to complete the cybersecurity training course.

In some implementations of the system, sending the prompt to the user may include generating and sending an email, text, or instant message prompt with a link to the cybersecurity training course.

In some implementations of the system, the cybersecurity simulation completion condition may include the expiry of the cybersecurity simulation. In some implementations of the system, the system may include means for providing the user with a link to an external platform with an option to access the cybersecurity training course.

Even another aspect of the present disclosure relates to a computing platform configured for providing cybersecurity simulation and training. The computing platform may include a non-transient computer-readable storage medium having executable instructions embodied thereon. The computing platform may include one or more hardware processors configured to execute the instructions. The processor(s) may execute the instructions to generate a cybersecurity simulation including a set of simulation elements selected from a simulation and training database. The set of simulation elements may be associated with a set of simulation characteristics. The processor(s) may execute the instructions to, in response to detection of a cybersecurity simulation completion condition, dynamically generate a cybersecurity training course including a set of training elements corresponding to the set of simulation characteristics, the set of training elements selected from the simulation and training database. The processor(s) may execute the instructions to, in response to identification of a change to the cybersecurity simulation, modify the cybersecurity training course based on the identified change to the cybersecurity simulation.

In some implementations of the computing platform, the cybersecurity simulation completion condition may include a user response to the cybersecurity simulation or expiry of the cybersecurity simulation.

In some implementations of the computing platform, the processor(s) may execute the instructions to, in response to identification of a change to the set of simulation elements, modify the set of training elements based on the identified change to the set of simulation elements.

In some implementations of the computing platform, the processor(s) may execute the instructions to, in response to identification of a change to the set of simulation characteristics, modify the set of training elements based on the identified change to the set of simulation characteristics.

In some implementations of the computing platform, the cybersecurity simulation may include a simulation identifier. In some implementations of the computing platform, the processor(s) may execute the instructions to dynamically generate training data for the cybersecurity training course based on the simulation identifier.

In some implementations of the computing platform, the cybersecurity simulation may include a simulation identifier. In some implementations of the computing platform, the cybersecurity training course includes training data delivered may use a presentation format. In some implementations of the computing platform, the processor(s) may execute the instructions to dynamically generate training data for the cybersecurity training course based on the simulation identifier. In some implementations of the computing platform, the processor(s) may execute the instructions to dynamically present the training data using a presentation format based on a user identifier.

In some implementations of the computing platform, the processor(s) may execute the instructions to embed at least a portion of the cybersecurity simulation in the cybersecurity training course.

In some implementations of the computing platform, the processor(s) may execute the instructions to access the simulation and training database to select the set of simulation elements. In some implementations of the computing platform, the set of simulation elements may include one or more of emotional intent criteria adjusters, cues for identifying a phish or other cybersecurity scam, difficulty level of the cybersecurity simulation based on context and relevancy to the organization or the end user, explanations and/or advice for identifying future cybersecurity scams, and user personality adjusters.

In some implementations of the computing platform, the processor(s) may execute the instructions to send the cybersecurity training course to the user via email, text, or instant message.

In some implementations of the computing platform, sending the cybersecurity training course to the user may include sending the user a link to the cybersecurity training course hosted on an external platform.

In some implementations of the computing platform, the cybersecurity simulation may be sent to the user at a time t1 and the cybersecurity training course is sent to the user at a time t2 wherein the time t2 is after the detection of the cybersecurity simulation completion condition.

In some implementations of the computing platform, the time t2 may be at least 5 seconds after the detection of the cybersecurity simulation completion condition.

In some implementations of the computing platform, the processor(s) may execute the instructions to send a prompt to the user at the time t2 to complete the cybersecurity training course.

In some implementations of the computing platform, sending the prompt to the user may include generating and sending an email, text, or instant message prompt with a link to the cybersecurity training course.

In some implementations of the computing platform, the cybersecurity simulation completion condition may include the expiry of the cybersecurity simulation. In some implementations of the computing platform, the processor(s) may execute the instructions to provide the user with a link to an external platform with an option to access the cybersecurity training course.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A system configured for providing cybersecurity simulation and training, the system comprising:
a non-transient computer-readable storage medium having executable instructions embodied thereon; and
one or more hardware processors configured to execute the instructions to:
generate a cybersecurity simulation comprising a set of simulation elements selected from a simulation and training database, the set of simulation elements being associated with a set of simulation characteristics;
in response to detection of a cybersecurity simulation completion condition, dynamically generate a cybersecurity training course comprising a set of training elements corresponding to the set of simulation characteristics, the set of training elements selected from the simulation and training database; and
in response to identification of a change to the cybersecurity simulation, modify the cybersecurity training course based on the identified change to the cybersecurity simulation.

2. The computing platform of claim 1, wherein the cybersecurity simulation completion condition comprises a user response to the cybersecurity simulation or expiry of the cybersecurity simulation.

3. The computing platform of claim 1, wherein the one or more hardware processors are further configured by the instructions to:
in response to identification of a change to the set of simulation elements, modify the set of training elements based on the identified change to the set of simulation elements.

4. The computing platform of claim 1, wherein the one or more hardware processors are further configured by the instructions to:
in response to identification of a change to the set of simulation characteristics, modify the set of training elements based on the identified change to the set of simulation characteristics.

5. The system of claim 1, wherein the cybersecurity simulation comprises a simulation identifier, and the cybersecurity training course comprises training data delivered using a presentation format;
wherein the one or more hardware processors are further configured by the instructions to dynamically generate training data for the cybersecurity training course based on the simulation identifier;
wherein the one or more hardware processors are further configured by the instructions to dynamically present the training data using a presentation format based on a user identifier.

6. The system of claim 1, wherein the cybersecurity simulation is sent to the user at a time t1 and the cybersecurity training course is sent to the user at a time t2 wherein the time t2 is after the detection of the cybersecurity simulation completion condition.

7. The system of claim 1, wherein the cybersecurity simulation completion condition comprises expiry of the cybersecurity simulation, and
wherein the one or more hardware processors are further configured by the instructions to provide the user with a link to an external platform with an option to access the cybersecurity training course.

8. A method of providing cybersecurity simulation and training, the method comprising:
generating a cybersecurity simulation comprising a set of simulation elements selected from a simulation and training database, the set of simulation elements being associated with a set of simulation characteristics;
in response to detection of a cybersecurity simulation completion condition, dynamically generating a cybersecurity training course comprising a set of training elements corresponding to the set of simulation characteristics, the set of training elements selected from the simulation and training database; and
in response to identification of a change to the cybersecurity simulation, modifying the cybersecurity training course based on the identified change to the cybersecurity simulation.

9. The method of claim 8, wherein the cybersecurity simulation completion condition comprises a user response to the cybersecurity simulation or expiry of the cybersecurity simulation.

10. The method of claim 8, further comprising:
in response to identification of a change to the set of simulation elements, modifying the set of training elements based on the identified change to the set of simulation elements.

11. The method of claim 8, further comprising:
in response to identification of a change to the set of simulation characteristics, modifying the set of training elements based on the identified change to the set of simulation characteristics.

12. The method of claim 8, wherein the cybersecurity simulation comprises a simulation identifier, and the cybersecurity training course comprises training data delivered using a presentation format;
dynamically generating training data for the cybersecurity training course based on the simulation identifier; and
dynamically presenting the training data using a presentation format based on a user identifier.

13. The method of claim 8, wherein the cybersecurity simulation is sent to the user at a time t1 and the cybersecurity training course is sent to the user at a time t2 wherein the time t2 is after the detection of the cybersecurity simulation completion condition.

14. The method of claim 8, wherein the cybersecurity simulation completion condition comprises expiry of the cybersecurity simulation, and further comprising:
providing the user with a link to an external platform with an option to access the cybersecurity training course.

15. A non-transient computer-readable storage medium having instructions embodied thereon, the instructions being executable by one or more processors to perform a method for providing cybersecurity simulation and training, the method comprising:
generating a cybersecurity simulation comprising a set of simulation elements selected from a simulation and training database, the set of simulation elements being associated with a set of simulation characteristics;
in response to detection of a cybersecurity simulation completion condition, dynamically generating a cybersecurity training course comprising a set of training elements corresponding to the set of simulation characteristics, the set of training elements selected from the simulation and training database; and
in response to identification of a change to the cybersecurity simulation, modifying the cybersecurity training course based on the identified change to the cybersecurity simulation.

16. The computer-readable storage medium of claim 15, wherein the cybersecurity simulation completion condition comprises a user response to the cybersecurity simulation or expiry of the cybersecurity simulation.

17. The computer-readable storage medium of claim 15, wherein the method further comprises:
in response to identification of a change to the set of simulation elements, modifying the set of training elements based on the identified change to the set of simulation elements.

18. The computer-readable storage medium of claim 15, wherein the method further comprises:
in response to identification of a change to the set of simulation characteristics, modifying the set of training elements based on the identified change to the set of simulation characteristics.

19. The computer-readable storage medium of claim 15, wherein the cybersecurity simulation comprises a simulation identifier, and the cybersecurity training course comprises training data delivered using a presentation format;
wherein the method dynamically generating training data for the cybersecurity training course based on the simulation identifier; and
wherein the method dynamically presenting the training data using a presentation format based on a user identifier.

20. The computer-readable storage medium of claim 15, wherein the cybersecurity simulation is sent to the user at a time t1 and the cybersecurity training course is sent to the user at a time t2 wherein the time t2 is after the detection of the cybersecurity simulation completion condition.
